(19) United States
(12) Patent Application Publication
(10) Pub. No.: US 2015/0082654 A1
(43) Pub. Date: Mar. 26, 2015

(54) APPARATUS FOR HARDENING ULTRAVIOLET GEL FOR NAILS

(71) Applicant: TIANJIN M&C ELECTRONICS CO., LTD., Tianjin (CN)

(72) Inventors: Hyunseob JAEGAL, Tianjin (CN); Chunghyun ROH, Tianjin (CN)

(73) Assignee: TIANJIN M&C ELECTRONICS CO., LTD., Tianjin (CN)

(21) Appl. No.: 14/140,062

(22) Filed: Dec. 24, 2013

(30) Foreign Application Priority Data
Sep. 23, 2013 (KR) 10-2013-0112455

(51) Int. Cl. A45D 29/00; F26B 3/34

(52) U.S. Cl. CPC A45D 29/00; F26B 3/34
USPC 34/275

(57) ABSTRACT

Provided is an apparatus for hardening ultraviolet (UV) gel for nails, the apparatus including: a housing which is configured in such a way that an upper case of the housing ascends/descends and is rotatable with respect to a lower case so that enlargement/reduction and adjustment of a facing angle between the upper case and the lower case are capable of being performed; a mounting portion disposed on a top surface of the lower case so as to correspond to lengths and distances of user's fingers so that the user's fingers are capable of being mounted on the mounting portion; and UV mounting portions disposed on a bottom surface of the upper case to have an arrangement corresponding to the mounting portion so that UV rays are capable of being concentratively radiated onto user's nails placed on the mounting portion.

### CROSS-REFERENCE TO RELATED PATENT APPLICATION

This application claims the benefit of Korean Patent Application No. 10-2013-0112455, filed on Sep. 23, 2013, in the Korean Intellectual Property Office, the disclosure of which is incorporated herein in its entirety by reference.

### BACKGROUND OF THE INVENTION

1. Field of the Invention

The present invention relates to an apparatus for hardening ultraviolet (UV) gel for nails, and more particularly, to an apparatus for hardening UV gel for nails in which radiation angles and radiation distances of UV radiation portions are adjusted according to positions of nails and radiation positions of the UV radiation portions are arranged to correspond to the positions of the nails and the UV gel applied onto the nails can be hardened using UV rays.

2. Description of the Related Art

In general, people use a variety of ornaments, such as accessories, so as to show their own personalities. In particular, as young women pay attention to manicure and pedicure, in these days, nail art is sensationally popular.

Nail art means applying or printing various patterns, characters or symbols as well as simply painting fingernails and toenails. Nail art has advantages that are splendid and show more well an individual personality compared to a simple color manicure and thus, many women use nail art.

Here, nail art is generally configured by performing a method of applying and drying various polishes onto fingernails or toenails and coating ultraviolet (UV) gel so as to protect the fingernails or toenails. Also, a method of applying UV gel onto the fingernails or toenails and then attaching artificial fingernails or toenails onto the fingernails or toenails may be added.

In this case, an apparatus for hardening UV gel for nails is mainly used to harden the UV gel applied onto the fingernails or toenails. Korean Patent Registration No. 10-0888351 and 10-1213368 disclose an apparatus for hardening UV gel for nails.

Here, in an apparatus for hardening UV gel for nails according to the related art, in a state in which nails onto which the UV gel is applied, are placed on a bottom surface of an accommodation space in a housing having a polygonal shape in which a front side of the housing is open, UV rays are radiated onto the nails from UV radiation portions configured as UV light emitting diodes (LEDs) arranged on a ceiling surface above the bottom surface so that the UV gel can be hardened.

However, in the apparatus for hardening UV gel for nails according to the related art, a box-shaped housing is applied to a structure in which a separation distance between the bottom surface on which the nails are placed and the ceiling surface on which the UV radiation portions for radiating UV rays onto the bottom surface are placed is uniformly fixed.

Thus, when a radiation distance between the UV radiation portions and the nails is large according to the thickness of a user's individual finger and a height from the bottom surface to the ceiling surface of the housing, illumination and brightness are in inverse proportion to a square of the radiation distance and decrease, and a hardening time becomes long, and the user needs to put his/her hand up close to the ceiling surface and enables the nails to be close to the UV radiation portions, which causes usage inconveniences.

Also, in the apparatus for hardening UV gel for nails according to the related art, due to the above structure of the housing, radiation angles of the UV radiation portions are fixed perpendicular to the bottom surface. Thus, when the user bends his/her hand without spreading out his/her fingers or puts his/her wrist up and enables the nails to direct upwards, radiation angles between the nails and the UV radiation portions are not maintained in a perpendicular state and UV rays are not concentratively radiated onto the rails, and the hardening time becomes long. Also, there are inconveniences that the user should continuously maintain a fingers-spread-out state.

Also, in the apparatus for hardening UV gel for nails according to the related art, UV LEDs that are the UV radiation portions are arranged on the central part or the entire area of the ceiling surface of the housing.

Thus, in a state in which the user cups his/her hand or spreads out fingers, UV rays are not concentratively radiated onto the nails, and the hardening time becomes long, and there are inconveniences that the user should continuously maintain a cupped-hand state or the fingers-spread-out state so as to correspond to arrangement positions of the UV radiation portions. Also, when the UV LEDs are arranged in the entire area of the ceiling surface, a large number of UV LEDs are required, and thus, manufacturing costs increase.

### SUMMARY OF THE INVENTION

The present invention provides an apparatus for hardening ultraviolet (UV) gel for nails in which a radiation distance and a radiation angle of an upper case on which UV radiation portions are to be configured, and a lower case are adjusted so that hardening efficiency can be improved and usage conveniences can be provided.

The present invention also provides an apparatus for hardening ultraviolet (UV) gel for nails in which UV radiation portions are arranged in such a way that a mounting portion on which user's fingers are placed is disposed on a lower case and an upper case corresponds to the mounting portion so that hardening efficiency can be improved and usage conveniences can be provided.

Objectives of the present invention are not limited to the objectives mentioned above, and other unmentioned objectives will be clearly understood by one of ordinary skill in the art from the following description.

According to an aspect of the present invention, there is provided an apparatus for hardening ultraviolet (UV) gel for nails, the apparatus including: a housing which is configured in such a way that an upper case of the housing ascends/descends and is rotatable with respect to a lower case so that enlargement/reduction and adjustment of a facing angle between the upper case and the lower case are capable of being performed; a mounting portion disposed on a top surface of the lower case so that user's fingers are capable of being mounted on the mounting portion; and UV mounting portions disposed on a bottom surface of the upper case so that UV rays are capable of being radiated onto user's nails placed on the mounting portion.

According to another aspect of the present invention, there is provided an apparatus for hardening ultraviolet (UV) gel for nails, the apparatus including: a housing including an upper case and a lower case; a mounting portion disposed on a top surface of the lower case to correspond to lengths and distances of user's fingers so that the user's fingers are capable of being mounted on the mounting portion; and UV mounting portions disposed on a bottom surface of the upper case so that UV rays are capable of being radiated onto user's nails placed on the mounting portion.

According to still another aspect of the present invention, there is provided an apparatus for hardening ultraviolet (UV) gel for nails, the apparatus including: a housing including an upper case and a lower case; a mounting portion disposed on a top surface of the lower case so that user's fingers are capable of being mounted on the mounting portion; and UV mounting portions arranged on a bottom surface of the upper case so as to correspond to lengths and distances of the user's fingers so that UV rays are capable of being concentratively radiated onto user's nails.

According to yet still another aspect of the present invention, there is provided an apparatus for hardening ultraviolet (UV) gel for nails, the apparatus including: a housing which is configured in such a way that an upper case of the housing ascends/descends and is rotatable with respect to a lower case so that enlargement/reduction and adjustment of a facing angle between the upper case and the lower case are capable of being performed; a mounting portion disposed on a top surface of the lower case so as to correspond to lengths and distances of user's fingers so that the user's fingers are capable of being mounted on the mounting portion; and UV mounting portions disposed on a bottom surface of the upper case to have an arrangement corresponding to the mounting portion so that UV rays are capable of being concentratively radiated onto user's nails placed on the mounting portion.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an apparatus for hardening ultraviolet (UV) gel for nails according to an exemplary embodiment of the present invention;

FIGS. 2 and 3 illustrate a mounting portion disposed on a lower case and a UV radiation portion disposed on a lower case of the apparatus for hardening UV gel for nails illustrated in FIG. 1;

FIG. 4 illustrates ascending/descending and rotation operation states of the upper case and the lower case of the apparatus for hardening UV gel for nails of FIG. 1; and

FIG. 5 is a block diagram illustrating elements of the apparatus for hardening UV gel for nails of FIG. 1.

### DETAILED DESCRIPTION OF THE INVENTION

The present invention will now be described more fully with reference to the accompanying drawings, in which exemplary embodiments of the invention are shown.

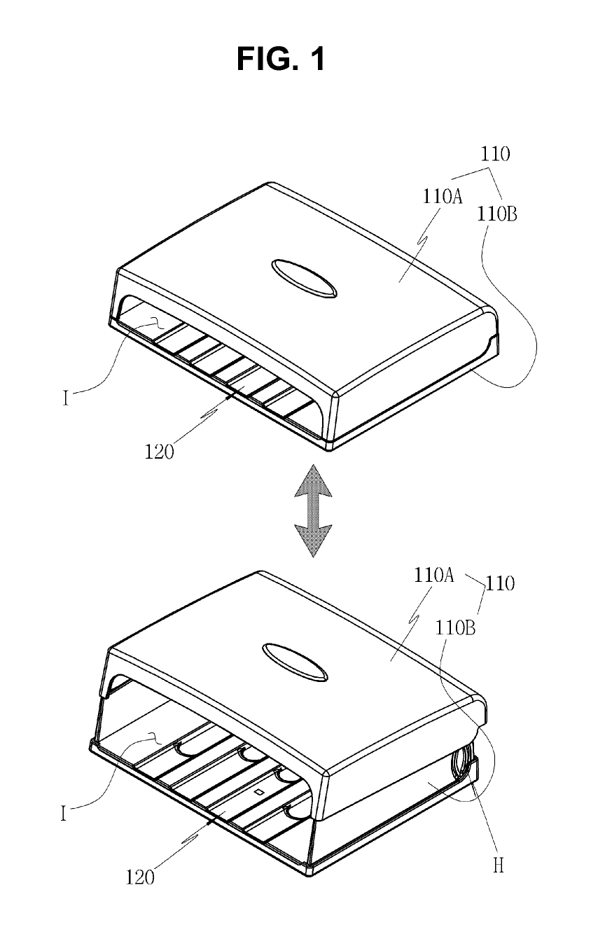

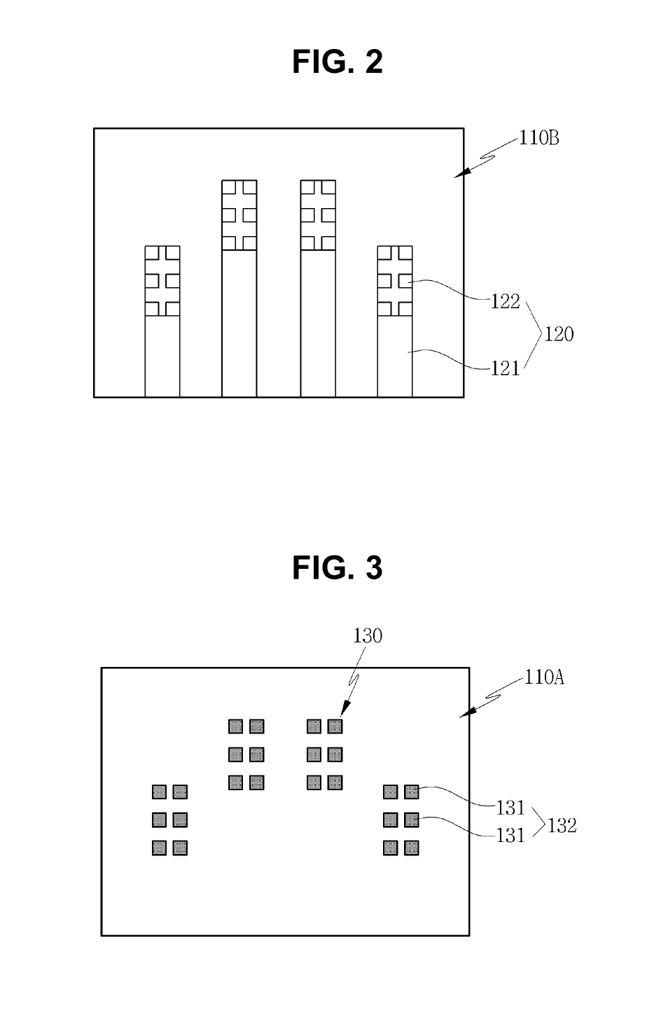

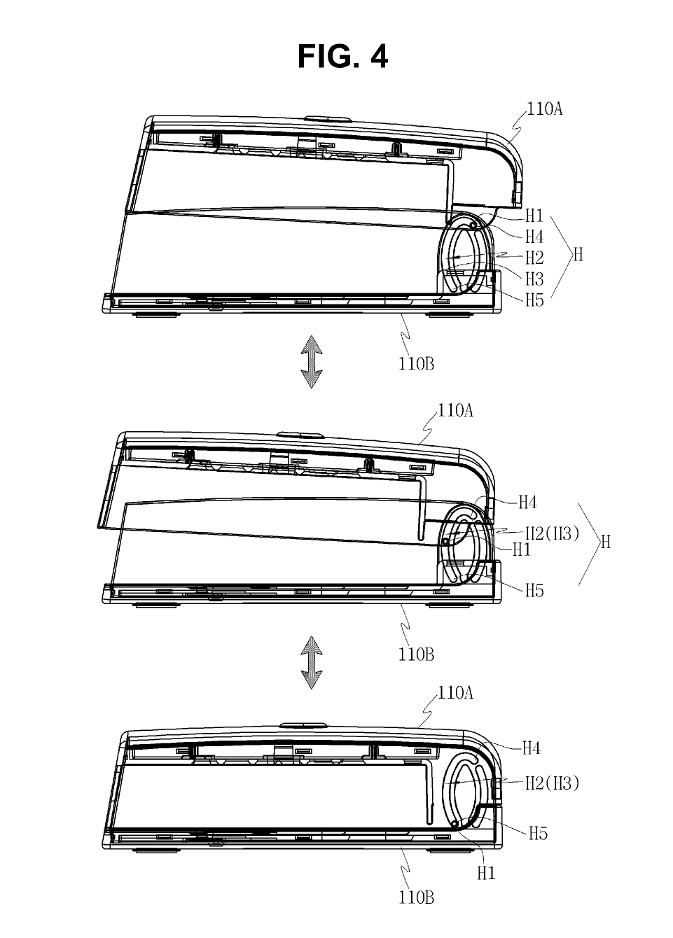

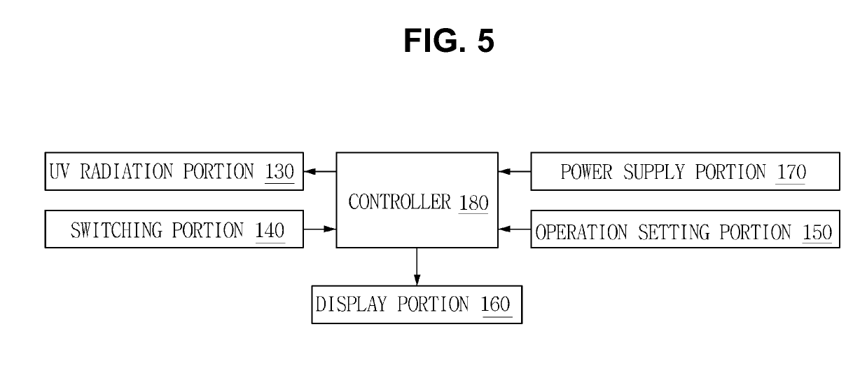

FIG. 1 is a perspective view of an apparatus for hardening ultraviolet (UV) gel for nails according to an exemplary embodiment of the present invention, FIGS. 2 and 3 illustrate a mounting portion disposed on a lower case and a UV radiation portion disposed on a lower case of the apparatus for hardening UV gel for nails illustrated in FIG. 1, FIG. 4 illustrates ascending/descending and rotation operation states of the upper case and the lower case of the apparatus for hardening UV gel for nails of FIG. 1, and FIG. 5 is a block diagram illustrating elements of the apparatus for hardening UV gel for nails of FIG. 1.

As illustrated in FIGS. 1 through 4, the apparatus for hardening UV gel for nails according to an exemplary embodiment of the present invention includes a housing 110, a mounting portion 120, and UV radiation portions 130.

The housing 110 is configured in such a way that an upper case 110A of the housing 110 ascends/descends and is rotatable with respect to a lower case 110B so that enlargement/reduction and adjustment of a facing angle between the upper case 110A and the lower case 110B can be performed.

The mounting portion 120 is configured on a top surface of the lower case 110B to correspond to lengths and distances of fingers of a user so that the user's fingers can be mounted on the mounting portion 120.

The UV radiation portions 130 are configured on a bottom surface of the upper case 110A to have an arrangement corresponding to the mounting portion 120 so that UV rays can be concentratively radiated onto user′ nails placed on the mounting portion 120.

As illustrated in FIG. 5, the apparatus for hardening UV gel for nails of FIG. 1 further includes a switching portion 140, an operation setting portion 150, a display portion 160, a power supply portion 170, and a controller 180.

The switching portion 140 is configured at the housing 110 and generates on/off signals.

The operation setting portion 150 is disposed at the housing 110 and generates operating signals according to an operating time, the number of operations and an operating mode of the UV radiation portions 130 when the switching portion 140 generates on signals.

The display portion 160 displays corresponding information, such as operating states of the UV radiation portions 130, when signals are generated from the switching portion 140 and the operation setting portion 150.

The power supply portion 170 supplies operating power to the UV radiation portions 130, the switching portion 140, the operation setting portion 150, and the display portion 160.

The controller 180 is electrically connected to the UV radiation portions 130, the switching portion 140, the operation setting portion 150, the display portion 160 and the power supply portion 170 and performs overall operation control of outputting control signals used to control an operation of the UV radiation portions 130 to correspond to operation setting information after initial switching has been performed and displaying an output state of the control signals on the display portion 160.

Referring back to FIGS. 1 through 4, the housing 110 is configured in such a way that, in a state in which rear ends of the upper case 110A and the lower case 110B are combined with each other to ascend/descend and to be rotatable via a connection unit H, the upper case 110A is spaced apart from or is close to the lower case 110B when the upper case 110A ascends/descends along the connection unit H so that an insertion portion I can be enlarged or reduced and the upper case 110A is rotated with respect to the lower case 110B at a predetermined angle via the connection unit H so that a facing angle between the upper case 110A and the lower case 110B can be adjusted.

Here, in a state in which sidewalls of the upper case 110A are formed to have a predetermined height at a portion in which a front side and a bottom surface of the housing 110 are excluded, of a panel-shaped bottom surface and sidewalls of the lower case 110B are formed to have a predetermined height at a portion in which a front side and a ceiling surface of the housing 110 are excluded, of the panel-shaped bottom surface, facing rear ends of the upper case 110A and the lower case 110B are combined with each other via the connection unit H so that the insertion portion I into which a finger is inserted, can be formed in a front opening part.

The connection unit H is configured by combining slide pins H1 disposed at both inner sides of the rear end of the upper case 110A and slide cores H2 disposed at both inner sides of the rear end of the lower case 110B, with each other. Each of the slide pins H1 inserted into a wired slide rail H3 formed on each of the slide cores H2 ascend or descend along the slide rail H3 so that the upper case 110A and the lower case 110B can be spaced apart from each other or can be close to each other, and each of the slide pins H1 inserted into the slide rail H3 is rotated so that a facing angle between the upper case 110A and the lower case 110B can be adjusted.

Here, the slide rail H3 has an arch shape. Thus, when the slide pin H1 is placed in a hanging groove H4 that corresponds to an arch-shaped upper part of the slide rail H3, the spaced state of the upper case 110A and the lower case 110B can be continuously maintained.

Also, the slide pin H1 may be configured as a hinge structure having a well-known fixing portion that causes a rotation angle when the slide pin H1 is rotated in the hanging groove H4 of the slide rail H3 at a predetermined angle, to be fixed.

That is, the housing 110 is configured in such a way that, when the upper case 110A connected to the lower case 110B slides upwards via the connection unit H, the insertion portion I can be enlarged so that insertion of the finger can be easily performed and contrary to this, when the upper case 110A slides downwards, the insertion portion I can be reduced so that the volume of the apparatus for hardening UV gel for nails can be minimized, portability thereof can be improved and a facing angle between the upper case 110A and the lower case 110B can be adjusted when a rotation operation is performed.

Thus, according to the housing 110, in a state in which the upper case 110A and the lower case 110B are connected to be rotatable with respect to each other, the rear end of the upper case 110A sliding ascends/descends and are rotated with respect to the rear end of the lower case 110B so that a radiation distance and a radiation angle between the UV radiation portions 130 disposed on the upper case 110A and the mounting portion 120 disposed on the lower case 110B can be adjusted, hardening efficiency can be improved and usage conveniences can be provided.

That is, a separation height of the mounting portion 120 and the UV radiation portions 130 is adjusted to correspond to the thickness of a user's individual finger mounted on the mounting portion 120 so that a radiation distance between the UV radiation portions 130 and the nails can be reduced, illumination and brightness increase and a hardening time can be reduced. In addition, the user does not need to put his/her hand up close to the UV radiation portions 130 so that convenient usage can be made.

Also, even when the user cups his/her hand without spreading out fingers or puts his/her wrist up to direct upwards, the radiation angle between the nails and the UV radiation portions 130 may vary in a perpendicular state so that concentrative UV radiation can be performed on the nails, the hardening time can be reduced and the user does not need to continuously maintain a fingers-spread-out state and thus convenient usage can be made.

A reflective member may be disposed on a facing surface of the upper case 110A and the lower case 110B and inner surfaces of the sidewalls of the upper case 110A and the lower case 110B so that radiation efficiency of UV rays radiated from the UV radiation portions 130 that will be described below can be improved.

Also, owing to the sidewalls formed on the upper case 110A and the lower case 110B, even when UV rays are radiated onto an upper part of the lower case 110B in a state in which the upper case 110A is spaced apart from the lower case 110B, the UV rays are not exposed directly to the user.

The mounting portion 120 is disposed on a top surface of the lower case 110B to correspond to lengths and distances of user's fingers so that the user's fingers can be mounted on the mounting portion 120. The mounting portion 120 includes finger guides 121 arranged in a fan shape or a semicircular shape in a state in which the user spreads out his/her fingers naturally and nail guides 122 placed at ends of the finger guides 121.

Here, at least one of the finger guides 121 and the nail guides 122 may be formed in a predetermined uneven structure on a top surface of the lower case 110B.

Thus, according to the mounting portion 120, user's fingers' and nails' optimal positions on the top surface of the lower case 110B are guided to the user via the finger guides 121 and the nail guides 122 so that UV rays of the UV radiation portions 130 having an arrangement corresponding to the mounting portion 120 can be concentratively radiated onto the nails and hardening efficiency can be improved.

The UV radiation portions 130 are arranged so that UV rays can be concentratively radiated onto the user's nails placed on the mounting portion 120 on a bottom surface of the upper case 110A. The UV radiation portions 130 may be arranged so that UV light emitting diode (LED) modules 132 in which a plurality of UV LEDs 131 are arranged, correspond to positions of the nail guides 122 and UV rays can be concentratively radiated onto the user's nails placed at the nail guides 122.

The plurality of UV LEDs 131 may have a wavelength band that is close to a boundary between a visible light region and a UV ray region, for example, a wavelength band of 400 to 410 nm.

The UV LED modules 132 are configured by easily mounting surface mount type UV LEDs 131 on a printed circuit board (PCB) that is a chip mount so that manufacturing and productivity of the apparatus for hardening UV gel for nails can be improved.

Here, since UV rays radiated from the UV LEDs 131 generally have a Gaussian distribution, i.e., a light quantity distribution having a curved surface shape that corresponds to curved surfaces of the nails, a light quantity is concentrated only on the center of the nails and is rapidly dispersed toward an outer side of the nails so that hardening in the center of the nails is quickly performed and hardening at edges of the nails is slowly performed and thus birdcaging, exfoliation, or efflorescence occurs.

Thus, each of the UV radiation portions 130 includes an additional lens member that is disposed at an outer surface of each UV LED module 132 including a first lens having a semicircular cross-section and a second lens having an oval cross-section, thereby protecting the UV LEDs 131 and simultaneously causes a light quantity distribution of UV rays radiated from the UV LEDs 131 to have a light quantity distribution having a curved surface shape that corresponds to curved surfaces of the nails so that hardening efficiency of the UV gel applied onto the nails can be improved.

Thus, according to the UV radiation portions 130, the UV LED modules 132 in which the plurality of UV LEDs 131 are arranged, are arranged to correspond to positions of the nail guides 122 so that UV rays can be concentratively radiated onto the user's nails placed on the nail guides 122 using only a small number of UV LEDs 131.

That is, in a state in which the user's nails are placed comfortably on the nail guides 122, UV rays are concentratively radiated onto the nails from the UV LEDs 131 of the UV LED modules 132 corresponding to the nail guides 122 so that a hardening time can be reduced and the user does not need to change positions of the nails toward the UV LED modules 132 and thus convenient usage can be made.

Meanwhile, referring to FIG. 5, the switching portion 140 is a switching portion that is disposed at an outer rear side of the lower case 110B of the housing 110 or an outer side of the upper case 110A and generates on/off signals. The switching portion 140 may be additionally configured outside the housing 110 or may be configured as a sensing unit, such as a resistive or capacitive touch sensor that senses user's finger touch on the nail guides 122 or the bottom surface of the lower case 110B, so as to generate switching signals corresponding the on/off signals while the touch sensor operates.

The operation setting portion 150 is an input unit that is disposed at one side of the switching portion 140 and generates operating signals according to an operating time, the number of operations and an operating mode of the UV radiation portions 130 when the switching portion 140 generates on/off signals. The operation setting portion 150 may be configured as a plurality of buttons or dials for generating corresponding operating signals.

The display portion 160 is a display unit that is disposed at one side of the housing 110 and displays information, such as an operating state of the UV radiation portions 130, when signals are generated by the switching portion 140 and the operating setting portion 150. The display potion 160 may be a display unit, such as a liquid crystal display (LCD).

The power supply portion 170 is a power supply unit that supplies operating power to the UV radiation portions 130, the switching portion 140, the operation setting portion 150 and the display portion 160. The power supply portion 170 may be configured by installing a battery inside the housing 110 to be mounted on/detached from the housing 110 or by installing a universal serial bus (USB) port that causes operating power to be supplied from the outside via an additional adaptor.

The controller 180 is a control unit that is electrically connected to the UV radiation portions 130, the switching portion 140, the operation setting portion 150, the display portion 160 and the power supply portion 170 and performs overall operation control of outputting control signals used to control an operation of the UV radiation portions 130 to correspond to operation setting information after initial switching has been performed and displaying an output state of the control signals on the display portion 160. The above-described operation control is well-known and thus, detailed descriptions thereof will be omitted.

Hereinafter, an operation of the apparatus for hardening UV gel for nails illustrated in FIG. 1 will be described.

First, the slide pin H1 of the connection unit H disposed on the upper case 110A slides upwards along the slide rail H3 of the slide core H2 disposed on the lower case 110B and then is hung in the hanging groove H4 of the slide rail H3, the upper case 110A is spaced apart from the lower case 110B by a predetermined height and the insertion portion I of the housing 110 is enlarged so that user's fingers can be easily inserted into the insertion portion I.

Subsequently, if the user mounts fingers in a naturally spread-out state on the mounting portion 120 disposed on the lower case 110B, UV rays are radiated onto the user's nails from the UV radiation portions 130 that operate by the controller 180 so that hardening of the UV gel is performed.

Thus, as described above, as the UV LED modules 132 of the UV radiation portions 130 are arranged to correspond to the nails placed on the mounting portion 120, UV rays can be concentratively radiated onto the nails using only a small number of UV LEDs 131.

If the slide pin H1 of the connection unit H disposed on the upper case 110A is rotated at a predetermined angle in a state in which the slide pin H1 is placed in the hanging groove H4 of the slide rail H3 disposed on the lower case 110B, a facing angle between the mounting portion 120 and the UV radiation portion 130 is adjusted.

Thus, as described above, the separation height of the mounting portion 120 and the UV radiation portions 130 and a facing angle therebetween can be reduced so as to correspond to the thickness of a user's individual finger mounted on the mounting portion. Thus, illumination and brightness increase and a hardening time can be reduced.

In addition, even though the user bends his/her hand without spreading out fingers or puts his/her wrist up to direct upwards, a radiation angle between the nails and the UV radiation portion 130 can vary in a perpendicular state so that UV radiation can be concentratively performed on the nails and a hardening time can be reduced.

In the above-described state, when the slide pin H1 of the connection unit H of the upper case 110A slides downwards from the hanging groove H4 of the slide rail H3 of the lower case 110B and then is placed in a reference groove H5 of the slide rail H3, the upper case 110A is close to the lower case 110B, and the insertion portion I of the housing 110 is reduced so that the volume of the apparatus for hardening UV gel for nails can be minimized and portability or storability thereof can be improved.

As described above, according to the one or more embodiments of the present invention, an upper case is configured to ascend or descend or to be rotatable with respect to a lower case, and a radiation distance and a radiation angle between a UV radiation portion of the upper case and a mounting portion of the lower case are adjusted so that hardening efficiency of UV gel applied onto nails can be improved.

In addition, as UV LED modules of UV radiation portions are arranged to correspond to the nails placed on the mounting portion, UV rays can be concentratively radiated onto the nails using a small number of UV LEDs.

In addition, a separation height between the mounting portion and the UV radiation portion can be reduced by an ascending/descending operation of the lower case and the upper case, so as to correspond to the thickness of a user's individual finger mounted on the mounting portion. Thus, illumination and brightness increase and a hardening time can be reduced.

In addition, even though the user bends his/her hand without spreading out fingers or puts his/her wrist up to direct upwards, a radiation angle between the nails and the UV radiation portion can vary in a perpendicular state by adjusting a rotation angle between the upper case and the lower case so that UV radiation can be concentratively performed on the nails and a hardening time can be reduced.

In addition, when the upper case is closed with respect to the lower case, the volume of an apparatus for hardening UV gel for nails is minimized and portability of the apparatus can be improved.

The effects of the present invention are not limited to the effects mentioned above, and other unmentioned effects will be clearly understood by one of ordinary skill in the art from the description of the claims.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An apparatus for hardening ultraviolet (UV) gel for nails, the apparatus comprising:
a housing which is configured in such a way that an upper case of the housing ascends/descends and is rotatable with respect to a lower case so that enlargement/reduction and adjustment of a facing angle between the upper case and the lower case are capable of being performed;
a mounting portion disposed on a top surface of the lower case so that user's fingers are capable of being mounted on the mounting portion; and
UV mounting portions disposed on a bottom surface of the upper case so that UV rays are capable of being radiated onto user's nails placed on the mounting portion.

2. An apparatus for hardening ultraviolet (UV) gel for nails, the apparatus comprising:
a housing comprising an upper case and a lower case;
a mounting portion disposed on a top surface of the lower case to correspond to lengths and distances of user's fingers so that the user's fingers are capable of being mounted on the mounting portion; and
UV mounting portions disposed on a bottom surface of the upper case so that UV rays are capable of being radiated onto user's nails placed on the mounting portion.

3. An apparatus for hardening ultraviolet (UV) gel for nails, the apparatus comprising:
a housing comprising an upper case and a lower case;
a mounting portion disposed on a top surface of the lower case so that user's fingers are capable of being mounted on the mounting portion; and
UV mounting portions arranged on a bottom surface of the upper case so as to correspond to lengths and distances of the user's fingers so that UV rays are capable of being concentratively radiated onto user's nails.

4. An apparatus for hardening ultraviolet (UV) gel for nails, the apparatus comprising:
a housing which is configured in such a way that an upper case of the housing ascends/descends and is rotatable with respect to a lower case so that enlargement/reduction and adjustment of a facing angle between the upper case and the lower case are capable of being performed;
a mounting portion disposed on a top surface of the lower case so as to correspond to lengths and distances of user's fingers so that the user's fingers are capable of being mounted on the mounting portion; and
UV mounting portions disposed on a bottom surface of the upper case to have an arrangement corresponding to the mounting portion so that UV rays are capable of being concentratively radiated onto user's nails placed on the mounting portion.

5. The apparatus of claim 4, wherein the upper case and the lower case are configured to ascend/descend and to be rotatable with respect to each other and are connected to each other via a connection unit, and
the connection unit is configured by combining slide pins disposed at both inner sides of a rear end of the upper case and slide cores disposed at both inner sides of a rear end of the lower case, with each other.

6. The apparatus of claim 5, wherein each of the slide rails has an arch shape, and
when the slide pin is placed in a hanging groove corresponding to an arch-shaped upper part of the slide rail, an open state of the upper case and the lower case is continuously maintained.

7. The apparatus of claim 5, wherein the slide pin has a hinge structure in which the slide pin is rotated at a predetermined angle.

8. The apparatus of claim 4, wherein the mounting portion comprises:
finger guides arranged in a fan shape or a semicircular shape in a state in which a user spreads out his/her fingers naturally; and
nail guide placed at ends of the finger guides.

9. The apparatus of claim 4, wherein the UV radiation portions are arranged so that UV light emitting diode (LED) modules in which a plurality of UV LEDs are arranged, correspond to a fan shape or a semicircular shape in a state in which the user spreads out his/her fingers naturally.

10. The apparatus of claim 4, wherein the UV radiation portions operate when a sensing unit disposed on the lower case touches user's fingers.
